(19) United States
(12) Patent Application Publication
(10) Pub. No.: US 2014/0096526 A1
(43) Pub. Date: Apr. 10, 2014

(54) SYSTEM FOR OPERATING A COMBUSTOR OF A GAS TURBINE

(71) Applicant: GENERAL ELECTRIC COMPANY, Schenectady, NY (US)

(72) Inventors: Elias Marquez, Queretaro (MX); Gregory Earl Jensen, Greenville, SC (US)

(73) Assignee: GENERAL ELECTRIC COMPANY, Schenectady, NY (US)

(21) Appl. No.: 13/646,885

(22) Filed: Oct. 8, 2012

(51) Int. Cl. F02C 1/00

(52) U.S. Cl. 60/734

(57) ABSTRACT

An end cover for a gas turbine combustor includes a main body configured to connect to a casing that at least partially surrounds a portion of the gas turbine. A fuel circuit extends within the main body of the end cover. An orifice extends through the main body. The orifice is in fluid communication with the fuel circuit. The end cover further includes a linear actuator. The linear actuator includes a flow control member that extends the fuel circuit and at least partially through the orifice.

### FIELD OF THE INVENTION

The present invention generally involves a combustor of a gas turbine. More particularly, the invention relates to a combustor that adjusts to fuels having varying fuel properties.

### BACKGROUND OF THE INVENTION

Combustors are widely used in commercial operations. For example, a typical gas turbine includes a compressor that supplies a compressed working fluid to a combustor. The combustor mixes fuel with the compressed working fluid and burns the mixture to produce combustion gases having a high temperature and pressure. The combustion gases exit the combustor and flow to a turbine where they expand to produce work.

Various fuels may be supplied to the combustor for combustion. For example, the combustor may be designed to operate using blast furnace gas, coke oven gas, natural gas, vaporized liquefied natural gas (LNG), propane, hydrogen, or combinations thereof. Each fuel type generally has different fuel properties such as energy density, water content, oxygen content and hydrocarbon content. In addition, the fuel properties may vary among fuels of the same type, depending on various factors such as the fuel supplier, purity, temperature, addition of diluents, etc. Changes in the fuel used for a particular gas turbine may change the operation and/or performance of various components in the gas turbine. For example, a change in the energy density of the fuel may change the dynamic pressure oscillation (instability), pressure, temperature, and output of the combustor. Therefore, it may be desirable to adjust the combustor to accommodate various fuels having different fuel properties.

Various efforts have been made to design and operate combustors with different fuels. For example, the operating limits of the combustor may be adjusted based on the energy density of a particular fuel. However, this solution may result in reduced operating limits for the combustor or other equipment associated with the gas turbine. Another solution for operating a combustor with more than one type of fuel is to shut down the combustor and replace one or more fuel nozzles with substitute nozzles having different sized fuel orifices, or to replace various pre-orifices set within an end cover upstream from the fuel nozzles. However, this method requires interruption of the service provided by the gas turbine, thereby resulting in unplanned and unwanted outages. As a result, an improved combustor that adjusts to fuels having varying fuel properties such as energy density would be desirable.

### BRIEF DESCRIPTION OF THE INVENTION

Aspects and advantages of the invention are set forth below in the following description, or may be obvious from the description, or may be learned through practice of the invention.

One embodiment of the present invention is an end cover for a gas turbine combustor. The end cover includes a main body that is configured to connect to a casing that at least partially surrounds a portion of the gas turbine. A fuel circuit extends within the main body of the end cover. An orifice extends at least partially through the main body. The orifice is in fluid communication with the fuel circuit. The end cover further includes a linear actuator. The linear actuator includes a flow control member that extends into the fuel circuit and at least partially through the orifice.

Another embodiment of the present invention is a combustor for a gas turbine. The combustor generally includes an end cover disposed at one end of the combustor. The end cover includes a main body. A fuel circuit extends across a portion of the main body. An orifice extends at least partially through the main body and is in fluid communication with the fuel circuit. A fuel nozzle extends downstream from the end cover and is in fluid communication with the orifice. A linear actuator having a flow control member extends into the fuel circuit. The flow control member extends at least partially through the orifice.

The present invention may also include a gas turbine. The gas turbine includes a compressor section, a combustion section downstream from the compressor section, and a turbine section downstream from the combustor. The combustion section includes a casing and a combustor that extends at least partially through the casing. The combustor includes an end cover connected to the casing. The end cover has a main body, a fuel circuit that extends across a portion of the main body, and an orifice that extends at least partially through the main body. The orifice is in fluid communication with the fuel circuit. A fuel nozzle is in fluid communication with the orifice and extends downstream from the main body. A linear actuator includes a flow control member that extends into the fuel circuit. The flow control member extends at least partially through the orifice.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 illustrates a cross section of an exemplary gas turbine according to one embodiment of the present disclosure;

FIG. 2 illustrates a cross section side view of a portion of an end cover of the gas turbine shown in FIG. 1;

FIG. 3 illustrates an enlarged cross section side view of the end cover as shown in FIG. 2;

FIG. 4 illustrates an enlarged cross section side view of a portion of the end cover as shown in FIG. 3, according to at least one embodiment of the present disclosure;

FIG. 5 illustrates an enlarged cross section side view of a portion of the end cover as shown in FIG. 3, according to at least one embodiment of the present disclosure; and

FIG. 6 illustrates a flow control member having a spherical flow restrictor according to one embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system for controlling a flow rate of a fuel flowing through an end cover of a combustor of a gas turbine. In particular, the system allows operators of gas turbines the flexibility to use different fuels having various fuel properties such as fuel density for combustion within the combustor without having to tear down the combustor to make various mechanical modifications to the end cover. As a result, the operators may reduce outage time and operating expense.

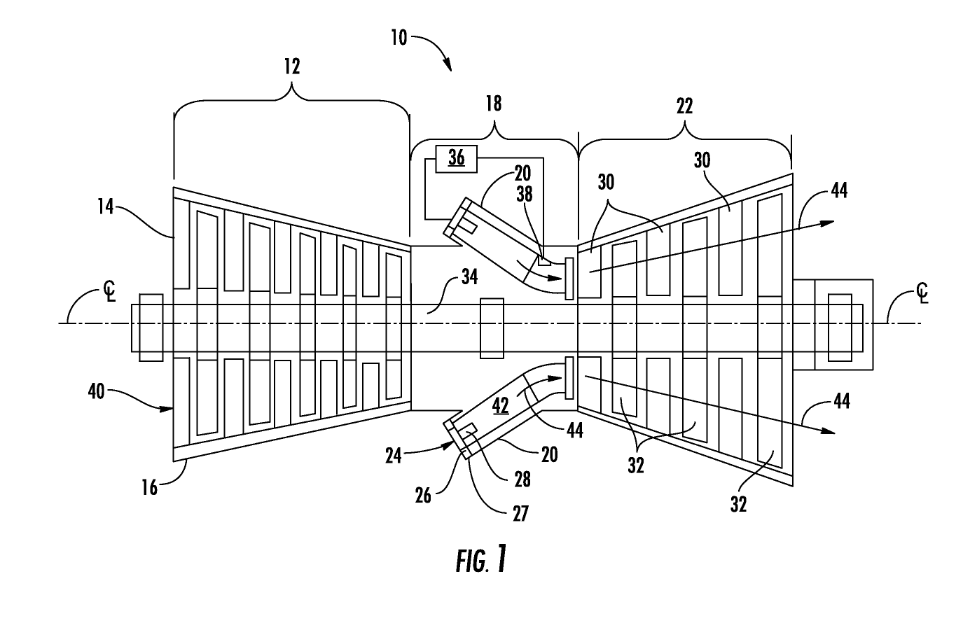

Referring now to the drawings, FIG. 1 illustrates an example of a known gas turbine 10. As shown, the gas turbine 10 generally includes a compressor section 12 having an inlet 14 disposed at an upstream end of the gas turbine 10, and a casing 16 that at least partially surrounds the compressor section 12. The gas turbine 10 further includes a combustion section 18 having a combustor 20 downstream from the compressor section 12, and a turbine section 22 downstream from the combustion section 18. A fuel supply 24 provides fuel to the combustor 20 through an end cover 26 connected to a casing 27 that at least partially surrounds the combustor 20. A fuel nozzle 28 extends from the end cover 26 and at partially through the combustor 20. The fuel nozzle 28 is in fluid communication with the fuel supply 24 through the end cover 26. The turbine section 22 generally includes alternating stages of stationary nozzles 30 and turbine rotor blades 32 disposed within the turbine section 22 along an axial centerline of a shaft 34 that extends generally axially through the gas turbine 10. As shown, the combustion section 18 may include a plurality of the combustors 20 circumferentially spaced around the axial centerline of the shaft 34.

In various embodiments, the gas turbine further includes a controller 36. The controller 36 may include any turbine control or power plant control system known in the art that permits the gas turbine 10 and/or the combustor 20 to be controlled and/or operated as described herein. Generally, the controller 36 may comprise any computer system having a processor(s) that executes programs, such as computer readable instructions stored in the controller's 36 memory to control the operation of the gas turbine 10 and/or the combustor 20 using sensor inputs and instructions from human operators.

In particular embodiments, the controller 36 is configured to receive and process a signal from a sensor 38 placed within gas turbine 10. For example, the sensor 38 may be placed within at least one of the combustion section 18, the fuel supply 24, the combustor 20 or the turbine section 22. In various embodiments, the sensor 38 is configured to sense at least one of pressure, emissions composition, temperature, combustion dynamic pressure oscillation (instability), or fuel composition. It should be appreciated by one of ordinary skill in the art that the gas turbine 10 may include multiple sensors 38 disposed throughout the gas turbine 10, and the disclosure is not intended to limit the scope of the invention to only one sensor 38 positioned within the combustor 20.

In operation, air 40 or other working fluid is drawn into the inlet 14 of the compressor section 12 and is compressed. The compressed air flows into the combustion section 18 and is mixed with fuel from the fuel nozzle 28 to form a combustible mixture. The combustible mixture is burned in a combustion chamber 42 defined within the combustor 20, thereby generating a hot gas 44 that flows from the combustion chamber 42 into the turbine section 22. The hot gas 44 rapidly expands as it flows through the alternating stages of stationary nozzles 30 and turbine rotor blades 32 of the turbine section 22. Thermal and/or kinetic energy is transferred from the hot gas 44 to each stage of the turbine rotor blades 32, thereby causing the shaft 34 to rotate and produce mechanical work. The shaft 34 may be coupled to a load such as a generator (not shown) so as to produce electricity. In addition or in the alternative, the shaft 34 may be used to drive the compressor section 12 of the gas turbine.

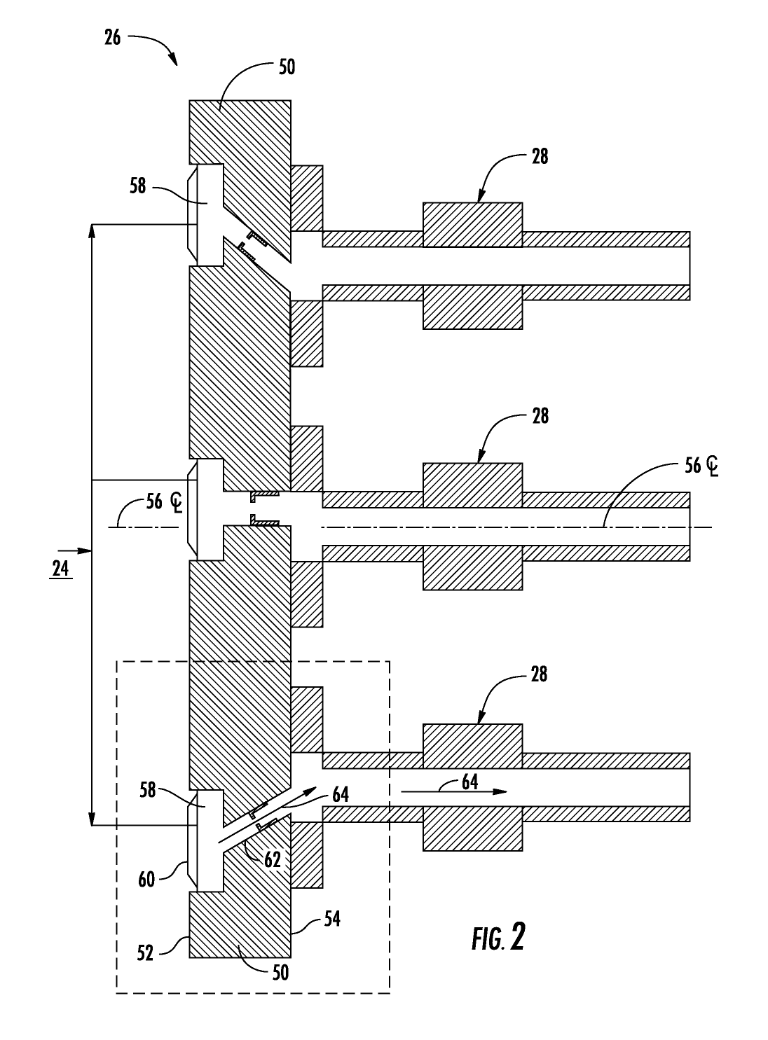

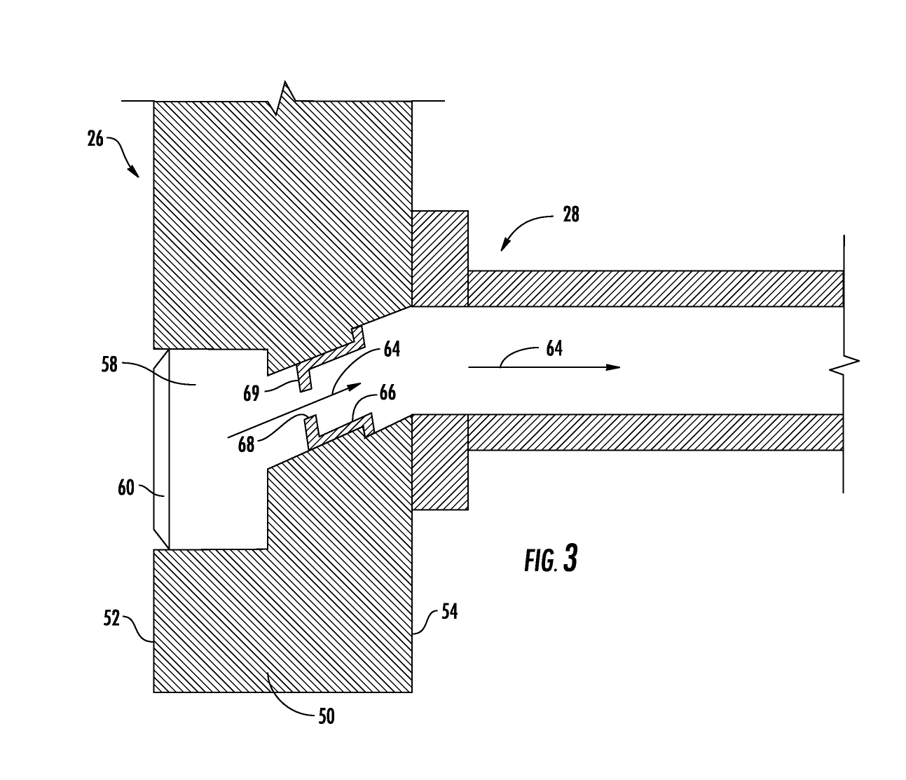

FIG. 2 illustrates a cross section side view of the end cover 26 as shown in FIG. 1 having multiple fuel nozzles 28, and FIG. 3 illustrates an enlarged cross section side view of a portion of the end cover as shown in FIG. 2, according to various embodiments of the present disclosure. In particular embodiments, as shown in FIG. 2, the end cover 26 includes a main body 50 having a first side 52 axially separated from a second side 54 with respect to an axial centerline 56 that extends through the end cover 26. A fuel circuit 58 extends at least partially across the first side 52 of the main body. In various embodiments, the fuel circuit 58 is at least partially defined by the main body 50. A plate 60 may be disposed generally adjacent to the first side 52 of the main body 50. The plate 60 may be any shape such as ring shaped so as to cover the fuel circuit 58. In particular embodiments, the plate 60 at least partially defines the fuel circuit 58. In the alternative, the first side 52 may have a solid/continuous surface. The fuel circuit 58 is in fluid communication with the fuel supply 24 shown in FIG. 1.

As shown in FIG. 2, an orifice 62 extends through the main body 50 between the fuel circuit 58 and the second side 54 of the main body 50. In various embodiments, the orifice 62 is defined by the main body 50. The orifice 62 at least partially defines a fluid flow path 64 that extends between the fuel circuit 58 and the fuel nozzle 28. A cross sectional area of the orifice 62 at least partially defines a fuel flow rate through the orifice. In further embodiments, as shown in FIG. 3, an orifice plug 66 may be positioned within the orifice 62. The orifice plug 66 may be seated in the orifice 62 in any manner know to one skilled in the art. For example, the orifice plug 66 may be brazed, welded or press fit.

A fluid port 68 extends through a top surface 69 of the orifice plug 66, thereby further defining the fluid flow path 64 extending through the orifice 62. A cross sectional area of the fluid port 68 at least partially defines a fuel flow rate through the orifice plug 66. The fluid port 68 may be generally circular, triangular or any shape suitable to allow fuel to flow through the orifice 62. In addition, the fluid port 68 may be tapered or conical. Although a singular fluid port 68 is shown, it should be appreciated by one of ordinary skill in the art that the orifice plug 66 may comprise of more than one fluid port 68 that extends through the top surface 69.

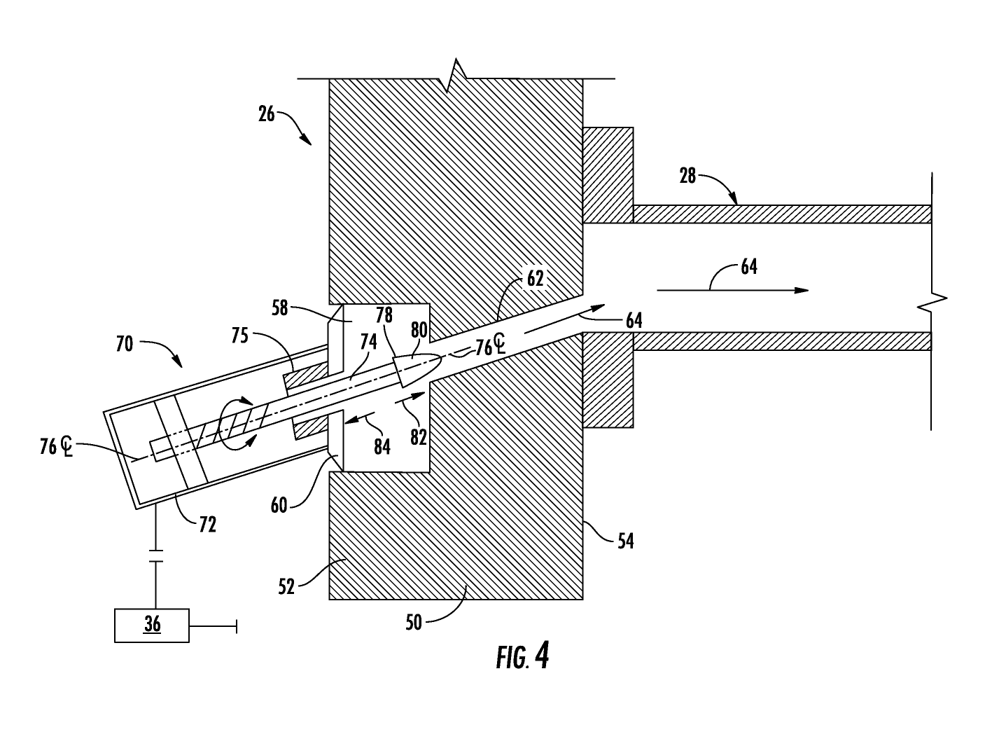

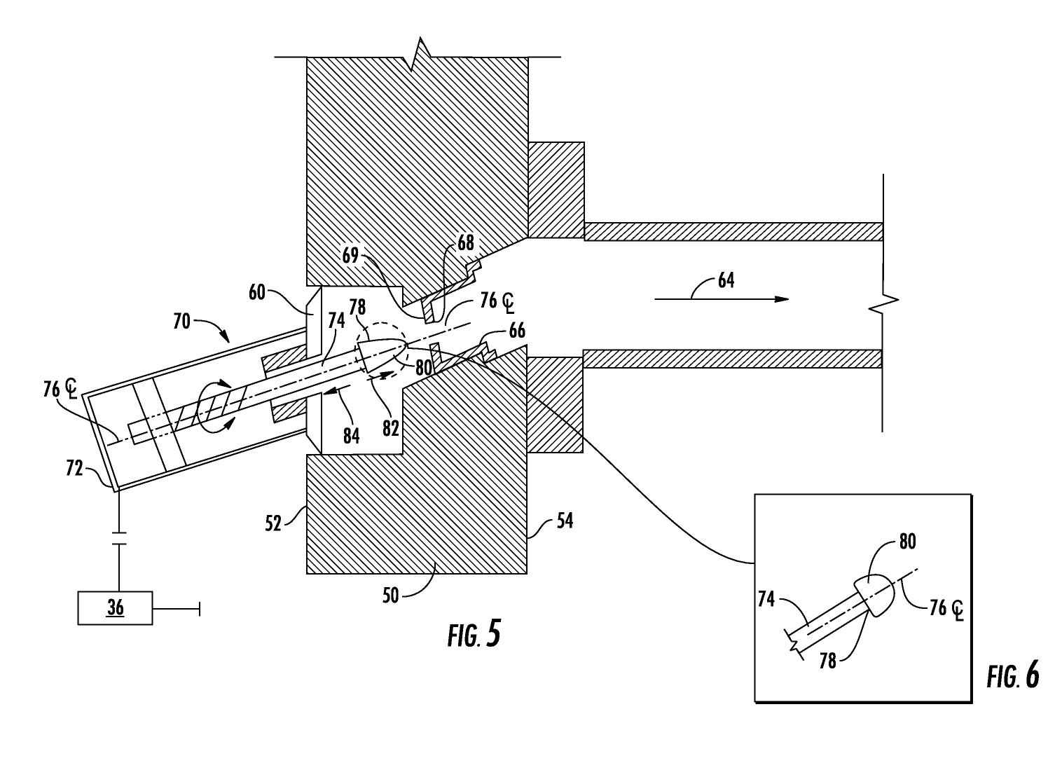

FIG. 4 illustrates an enlarged cross-section side view of a portion of the end cover 26 as shown in FIG. 2, according to at least one embodiment of the present disclosure. FIG. 5 illustrates an enlarged cross-section side view of a portion of the end cover 26 as shown in FIG. 4, according to an alternate embodiment of the present disclosure. In particular embodiments, as shown in FIGS. 4 and 5, the end cover 26 includes a system 70 herein referred to as “the system 70,” for modifying a fuel flow rate between the fuel circuit 58 and the fuel nozzle 28. As shown in FIG. 4, the system generally includes a linear actuator 72 configured to translate a flow control member 74 in a positive and a negative direction along an axial centerline 76 of the flow control member 74. The linear actuator 72 may include any type of linear actuator currently known in the art. For example, the linear actuator 72 may be one of a mechanical type, a hydraulic type, a pneumatic type, a piezoelectric type or an electro-mechanical type.

In particular embodiments, as shown in FIG. 4, the flow control member 74 is threaded to allow small incremental/precise movements of the flow member 74 along the axial centerline 76. The flow control member 74 has a forward end 78. A flow restrictor 80 extends from the forward end 78 along the axial centerline 76 of the flow control member 74. In particular embodiments, the flow restrictor 80 is conical, or as shown in FIG. 6 is spherical. However, it should be appreciated by one of ordinary skill that the flow restrictor 80 may be any shape suitable to implement the system 70 as described within the present disclosure. For example, the flow restrictor may be cylindrical, triangular, partially conical or partially spherical.

In various embodiments, as shown in FIGS. 4 and 5, the system 70 is mounted to the end cover 26 generally adjacent to the first side 52 of the main body 50. The system 70 may be welded, brazed or otherwise fixed to the end cover 26 by any means known in the art suitable to secure the system 70 to the end cover 26. The flow control member 74 extends into the fuel circuit 58. In various embodiments, the flow control member 74 extends through the plate 60 that at least partially defines the fuel circuit 58. In the alternative, the flow control member 74 may extend directly through the first side 52 of the main body 50 into the fuel circuit 58. In particular embodiments, a fitting 75 may extend through the plate 60 and/or the first side 52 of the main body 50. The fitting 75 may surround the flow control member 74, thereby preventing leakage of fuel from the fuel circuit 58.

In particular embodiments, as shown in FIG. 4, the flow restrictor 80 extends at least partially through the orifice 62. In operation, the linear actuator is activated to translate the flow control member 74 along the axial center line 76 of the flow control member 74, thereby translating the flow restrictor 80 in a forward direction 82 into the orifice 62, or translating the flow restrictor 80 in a rearward direction 84 out of the orifice 62. As a result, the flow area of the orifice 62 may be increased when the flow restrictor 80 is translated in the rearward direction 84 to allow a higher flow rate through the orifice 62, or the flow area of the orifice 62 may be decreased when the flow restrictor 80 is translated in the forward direction 82, thereby reducing the flow rate through the orifice 62. Although not shown, it should be obvious to one of ordinary skill in the art, that the flow restrictor 80 may be translated in the forward direction 82 to a point whereby the flow area of the orifice 62 is substantially zero, thereby sealing the orifice 62 and preventing fuel flow therethrough. For example, in some instances the flow rate may not change but the pressure at which the flow rate occurs will change when the flow restrictor is translated.

In an alternate embodiment, as shown in FIG. 5, the flow restrictor 80 extends at least partially through the fluid port 68 of the orifice plug 66. In operation, the linear actuator is activated to translate the flow control member 74 along the axial center line 76 of the flow control member 74, thereby translating the flow restrictor 80 in the forward direction 82 and into the fluid port 68 of the orifice plug 66, or translating the flow restrictor 80 in the rearward direction 84 out of the fluid port 68 of the orifice plug 66. As a result, the flow area of the fluid port 68 is increased when the flow restrictor 80 is translated in the rearward direction 84 to allow a higher flow rate through the fluid port 68. In the alternative, the flow area of the fuel port 68 is decreased when the flow restrictor 80 is translated in the forward direction 82, thereby reducing the flow rate through the fluid port 68. Although not shown, it should be obvious to one of ordinary skill in the art, that the flow restrictor 80 may be translated in the forward direction 82 to a point whereby the flow area of the fluid port 68 is substantially zero, thereby sealing the fluid port 68 and preventing fuel flow therethrough. For example, in some instances the flow rate may not change but the pressure at which the flow rate occurs will change when the flow restrictor is translated.

In particular an embodiment, as shown in FIGS. 4 and 5, the linear actuator is connected to the controller 36. The controller 36 generates a command signal based on the signal received from the sensor(s) 38, and the command signal manipulates the linear actuator 72. For example, if fuel composition changes during operation of the combustor 20, the sensor 38 sends a signal to the controller 36. The controller 36 analyzes the fuel composition, and the controller 36 generates a command signal that is sent from the controller 36 to the linear actuator 72. The linear actuator translates the flow control member 74 and the flow restrictor 80 in the forward 82 or the rearward 84 direction so as to increase or decrease the fuel flow area through the orifice 66 and/or the fluid port 68 of the orifice plug 66 to accommodate for the change in fuel composition. As a result, the change in fuel flow area may regulate fuel flow through to the fuel nozzles 28 so as to satisfy performance objectives of the gas turbine 10 while complying with operational boundaries of the combustor 20.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal language of the claims.

What is claimed is:

1. An end cover for a gas turbine combustor having a casing, the end cover comprising:
a. a main body configured to connect to the casing of the combustor;
b. a fuel circuit extending within the main body;
c. an orifice extending at least partially through the main body, the orifice being in fluid communication with the fuel circuit; and
d. a linear actuator having a flow control member, the flow control member extending into the fuel circuit and at least partially through the orifice.

2. The end cover as in claim 1, wherein the flow control member includes a flow restrictor that extends at least partially through the orifice, the flow restrictor being spherical or conical.

3. The end cover as in claim 1, wherein the linear actuator is one of a mechanical type, a hydraulic type, a pneumatic type, or an electro-mechanical type of linear actuator.

4. The end cover as in claim 1, wherein the fuel circuit is in fluid communication with a fuel supply.

5. The end cover as in claim 1, further comprising a fuel nozzle that extends downstream from the main body of the end cover, the orifice at least partially defining a flow path between the fuel circuit and the fuel nozzle.

6. The end cover as in claim 1, further comprising an orifice plug disposed within the orifice, the orifice plug defining a fluid port aligned with the flow control member of the linear actuator.

7. The end cover as in claim 6, wherein the flow control member extends at least partially through the fluid port of the orifice plug.

8. The end cover as in claim 1, further comprising a fitting that extends into the main body, the fitting surrounding the flow control member of the linear actuator.

9. A combustor for a gas turbine, comprising:
a. an end cover disposed at one end of the combustor, the end cover having a main body;
b. a fuel circuit that extends across a portion of the main body;
c. an orifice that extends at least partially through the main body, the orifice being in fluid communication with the fuel circuit;
d. a fuel nozzle downstream from the orifice; and
e. a linear actuator having a flow control member that extends into the fuel circuit, the flow control member extending at least partially through the orifice.

10. The combustor as in claim 9, wherein the flow control member is coaxially aligned with the orifice.

11. The combustor as in claim 9, wherein the flow control member includes a flow restrictor that extends at least partially through the orifice, the flow restrictor being spherical or conical.

12. The combustor as in claim 9, further comprising an orifice plug disposed within the orifice, the orifice plug defining a fluid port, the fluid port being aligned with the flow control member of the linear actuator.

13. The combustor as in claim 12, wherein the flow control member extends at least partially through the fluid port of the orifice plug.

14. A gas turbine comprising:
a. a compressor section, a combustion section downstream from the compressor section, and a turbine section downstream from the combustor, the combustion section having a casing and a combustor that extends at least partially through the casing, the combustor comprising:
i. an end cover connected to the casing, the end cover having a main body, a fuel circuit extending across a portion of the main body, and an orifice extending at least partially through the main body, the orifice being in fluid communication with the fuel circuit;
ii. a fuel nozzle that extends downstream from the main body, the fuel nozzle being in fluid communication with the orifice; and
iii. a linear actuator having a flow control member extending into the fuel circuit, the flow control member extending at least partially through the orifice.

15. The gas turbine as in claim 14, wherein the flow control member includes a flow restrictor that extends at least partially through the orifice, the flow restrictor being spherical or conical.

16. The gas turbine as in claim 14, wherein the linear actuator is one of a mechanical type, a hydraulic type, a pneumatic type, or an electro-mechanical type of linear actuator.

17. The gas turbine as in claim 14, wherein the fluid circuit is in fluid communication with one of a gas fuel supply, a liquid fuel supply or a purge air supply.

18. The gas turbine as in claim 14, further comprising an orifice plug disposed within the orifice of the end cover, and a fluid port extending through the orifice plug, the fluid port being aligned with the flow control member of the linear actuator.

19. The gas turbine as in claim 18, wherein the flow control member of the linear actuator extends at least partially through the fluid port.

20. The gas turbine as in claim 14, further comprising a controller, the controller connected to the linear actuator and to a sensor disposed within the combustor, the sensor being configured to sense at least one of pressure, emissions composition, temperature, combustion dynamic pressure oscillation, or fuel composition within the combustor, the controller being configured to send a command signal to the linear actuator.
